(19) United States
(12) Patent Application Publication
(10) Pub. No.: US 2025/0044915 A1
(43) Pub. Date: Feb. 6, 2025

(54) Curved Screen Skylight

(71) Applicant: Textron Aviation Inc., Wichita, KS (US)

(72) Inventors: Joshua Lawrence Bell, Wichita, KS (US); Stephen Howard Fagan, Wichita, KS (US); Michael Scott Robinson, Cheney, KS (US); Matthew R. Harrell, Wichita, KS (US)

(21) Appl. No.: 18/784,887

(22) Filed: Jul. 25, 2024

Related U.S. Application Data
(60) Provisional application No. 63/517,886, filed on Aug. 4, 2023.

(51) Int. Cl. G06F 3/0482; B64D 11/00; G06F 3/0484; H04N 7/18

(52) U.S. Cl. CPC G06F 3/0482; B64D 11/00; H04N 7/183; G06F 3/0484

(57) ABSTRACT

A curved screen skylight for an aircraft includes a curved display screen which is configured to display imagery provided from a camera positioned on the aircraft or preloaded imagery stored on a memory storage device. The curved screen display conforms to an aircraft overhead panel and can be secured using flanges extending from the overhead panel.

### CROSS-REFERENCE TO RELATED APPLICATIONS

This application claims the benefit of U.S. Provisional Patent Application No. 63/517,886, filed Aug. 4, 2023, the entire contents thereof are herein incorporated by reference.

### BACKGROUND OF THE INVENTION

### 1. Field

The disclosed embodiments relate generally to the field of visual display enhancement on an aircraft. More specifically, the disclosed embodiments relate to a system and method of virtual display capabilities for aircraft users.

### 2. Description of the Related Art

It is known for an aircraft to have a virtual window. For example, U.S. Patent Application Publication No. 2013/0169807 to de Carvalho et al. describes an electronic display mounted within the aircraft fuselage and a visual presentation element disposed on the outside of the aircraft fuselage in substantial registry with the electronic display mounted within the aircraft fuselage. The virtual window is shown to be a continuation of the cockpit window expanded to include part of the aircraft ceiling.

It is also known for an aircraft to have a projector to project an image onto a cabin surface. For example, European Patent No. 3683145 B1 to Madhav et al. describes an aircraft with windows and projectors positioned within the cabin area which are oriented to corresponding windows. The projectors project an image over the glass portion of the corresponding window and surrounding surfaces.

Aircraft are also known to have a system for displaying a panoramic view outside the aircraft onto a display inside of an aircraft. For example, U.S. Pat. No. 10,259,580 B2 to Teo describes a system with a camera positioned to capture video outside an aircraft and a processor to display the captured video on a display.

It is also known for an aircraft to contain a virtual window device having a frame and display. For example, U.S. Pat. No. 10,579,861 B2 to Kohlmeier-Beckmann describes a virtual window device, including a frame, with a display and a distance sensor unit configured to produce a distance signal, and a camera configured to capture a live video of a real scene. Then a computing unit is configured to control the display to the desired section.

It is also known for an aircraft vestibule to include a virtual display. For example, U.S. Pat. No. 10,891,504 B2 to Brauer describes an aircraft vestibule with a rest compartment having a virtual display element containing in flight entertainment or video captured by an external view camera.

Aircraft can also be equipped with a lower lobe passenger cabin with a virtual window. For example, U.S. Pat. No. 11,447,250 B2 to Behr et al. describes a lower lobe passenger rest cabin including a display surface that can be attached or pivoted for access to an in-flight entertainment system.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages will be apparent from the following detailed description of the embodiments and the accompanying drawing figures.

In some embodiments, the techniques described herein relate to a curved screen skylight for an aircraft including: a curved display screen substantially conformed to a ceiling of an aircraft cabin; a camera configured to provide a real-time external view from the aircraft and a memory storage device, wherein the camera and the memory storage device are communicatively coupled with the curved display screen; a user interface operatively coupled with the camera and the memory storage device; wherein the curved display screen is configured to display 1) a live video feed from the camera or 2) preloaded imagery stored on the memory storage device, and wherein the user interface enables a selection of the live video feed or the preloaded imagery to be displayed on the curved display screen.

In some embodiments, the techniques described herein relate to a curved screen skylight including an overhead panel having curvature to conform to the ceiling.

In some embodiments, the techniques described herein relate to a curved screen skylight including a display frame disposed around a perimeter of the curved display screen and configured to conform to the curvature of the overhead panel such that the display frame frames the curved display screen.

In some embodiments, the techniques described herein relate to a curved screen skylight wherein the display frame includes lighting elements which illuminate the display frame.

In some embodiments, the techniques described herein relate to a curved screen skylight including flanges which extend around a perimeter of the display frame and overlap an outer edge of the curved display screen.

In some embodiments, the techniques described herein relate to a curved screen skylight wherein the flanges are configured to embed the curved display screen within the overhead panel.

In some embodiments, the techniques described herein relate to a curved screen skylight wherein a viewable width is created in between the flanges such that the curved display screen displays either the preloaded imagery or the live video feed within the viewable width, and the viewable width is in a range of 15 inches to 25 inches wide.

In some embodiments, the techniques described herein relate to a curved screen skylight wherein a viewable length is created in between the flanges such that the curved display screen displays either the preloaded imagery or the live video feed within the viewable length, and the viewable length is in a range of 35 inches to 55 inches long.

In some embodiments, the techniques described herein relate to a curved screen skylight wherein the user interface enables a selection for augmented reality to be displayed on the curved display screen, and the augmented reality is stored on the memory storage device.

In some embodiments, the techniques described herein relate to a method for having a curved screen skylight for an aircraft, the method including: conforming a curved display screen to attach to a curved ceiling of an aircraft cabin; configuring a camera onto the aircraft and communicatively connecting the camera to a memory storage device and the curved display screen; and displaying at least one of, a live video feed from the camera, or preloaded imagery stored on the memory storage device onto the curved display screen.

In some embodiments, the techniques described herein relate to a curved screen skylight including providing a user interface operatively coupled to the curved display screen, wherein the user interface is configured to display a selectable menu on a human machine interface.

In some embodiments, the techniques described herein relate to a curved screen skylight wherein the selectable menu is configured to enable selection of either a) a live video feed from the camera, or b) preloaded imagery stored on the memory storage device, for displaying on the curved display screen.

In some embodiments, the techniques described herein relate to a curved screen skylight including disposing a display frame around the curved display screen and conforming the display frame to an overhead panel, such that the display frame encloses an outer portion of the curved display screen.

In some embodiments, the techniques described herein relate to a curved screen skylight including embedding the curved display screen into the overhead panel and securing the curved display screen using flanges extending from the overhead panel.

In some embodiments, the techniques described herein relate to a curved screen skylight including conforming the curved display screen to the overhead panel such that a standup height is substantially maintained inside the aircraft cabin.

In some embodiments, the techniques described herein relate to a curved screen skylight for an aircraft including: a curved display screen configured to be at least partially embedded into an aircraft ceiling; a camera communicatively connected to a memory storage device and the curved display screen; wherein the curved display screen is configured to display at least one of: a live video feed from the camera, or preloaded imagery stored on the memory storage device.

In some embodiments, the techniques described herein relate to a curved screen skylight including a user interface configured to enable a selection for displaying either the live video feed from the camera or the preloaded imagery stored on the memory storage device.

In some embodiments, the techniques described herein relate to a curved screen skylight including a display frame configured to create an edge around the curved display screen and attach to the aircraft ceiling.

In some embodiments, the techniques described herein relate to a curved screen skylight wherein a radius of curvature of the curved display screen is less than a radius of curvature of the aircraft ceiling.

In some embodiments, the techniques described herein relate to a curved screen skylight including flanges configured to extend from the aircraft ceiling and secure the curved display screen to the aircraft ceiling such that the curved display screen appears substantially embedded within the aircraft ceiling.

### BRIEF DESCRIPTION OF THE SEVERAL VIEWS OF THE DRAWINGS

Illustrative embodiments are described in detail below with reference to the attached drawing figures, which are incorporated by reference herein and wherein:

FIG. 1 is a view from within an aircraft cabin looking directionally upwards towards the curved screen skylight;

FIG. 2 is a method detailing a process to control the display of the curved screen skylight;

FIG. 3 is a cross-sectional view of the curved screen skylight mounted on an aircraft ceiling; and

FIG. 4 is a cross-sectional view of the curved screen skylight mounted on an aircraft ceiling.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

Embodiments provide systems and a method for providing virtual imagery to be disposed on a curved screen skylight located inside the main cabin fuselage area onboard an aircraft. Passengers onboard an airborne aircraft enjoy the experience of being able to see the environment surrounding the aircraft during flight. Currently, the passenger's visual experience is limited by the relatively small size of the passenger porthole windows on an aircraft, which are limited by the structural components (e.g., frames) on either side of each window. Increasing window size is difficult because removing a portion of the aircraft frame to accommodate a larger window requires additional structural fortification to compensate for the removed frame portions, which, overall, increases the weight of the aircraft. Proposed in disclosed embodiments is a curved screen skylight configured to display imagery on a curved display screen. This imagery, in some embodiments, may be selected and can be controlled by an aircraft user or occupant. The virtual nature of the skylight greatly increases the exterior visibility from within an aircraft while not requiring the aircraft frame to be modified. The proposed curved screen skylight in embodiments is low profile and capable of having a curvature which substantially conforms to the aircraft fuselage and does not impact a standup height inside the aircraft cabin.

The implementation of the curved display screen of the curved screen skylight should not be considered limiting within the scope of this application. The curved shape of the curved screen skylight can be achieved to match a curvature of an aircraft fuselage ceiling using numerous means. One possible means of implementation is to use a curved display/monitor or a series of displays/monitors substantially conformed to the curvature of the fuselage of the aircraft. In some embodiments, the curved display screen may include a fabric having micro perforations covering lighting elements (i.e. the display) configured to illuminate through the fabric. In some embodiments, the fabric may be translucent and in other embodiments the fabric may be semi-opaque. In embodiments with translucent or semi-opaque fabrics, lighting elements, which may be light emitting diodes, organic light emitting diodes, and/or electroluminescent lighting elements (LEDs, OLEDs, ELs), are substantially hidden behind the fabric and may only be visible when illuminated.

In embodiments, the curved screen skylight may be used to display a prerecorded, real-time, or near real-time feedback of the external environment of the aircraft, and may simulate other environments using augmented reality or a simulated feed. In some embodiments, a user may interact with augmented reality content. A camera configured to provide an outside view, positioned outside the aircraft or peering through a window from inside the aircraft may be used to capture and record a video or an image feed for displaying on the display screen of the virtual skylight. Additionally, other preloaded virtual images may be displayed in addition to or with camera feedback to create a visual environment desired by the user. The disclosed embodiments include a method to allow a user to display virtual imagery onto the virtual skylight.

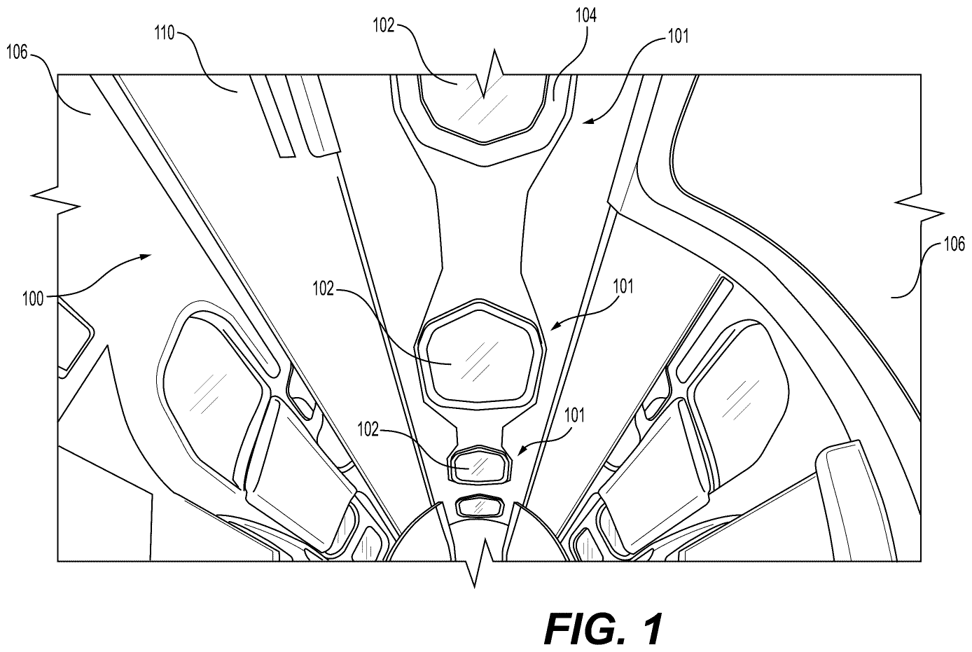

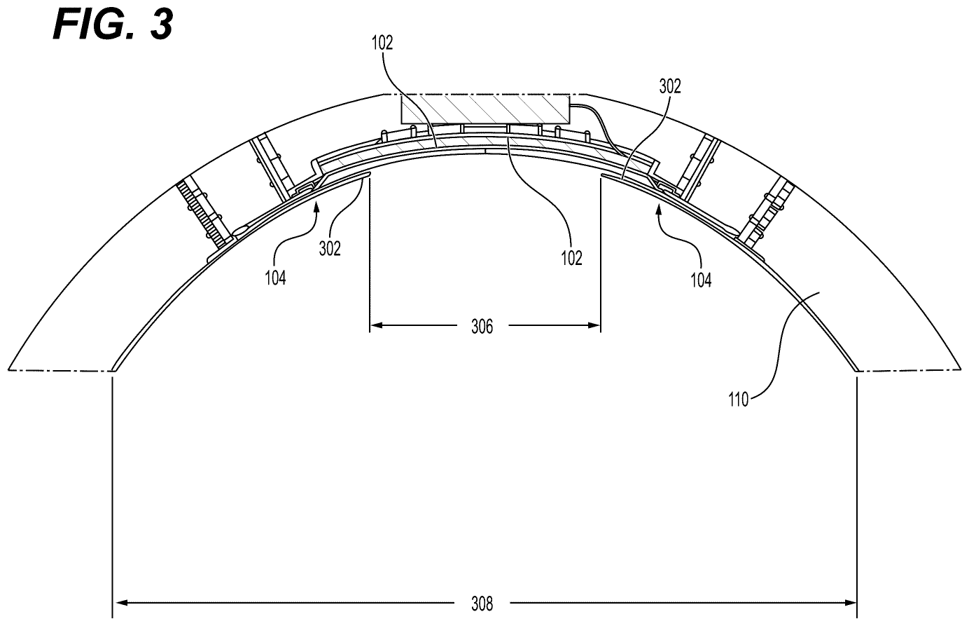

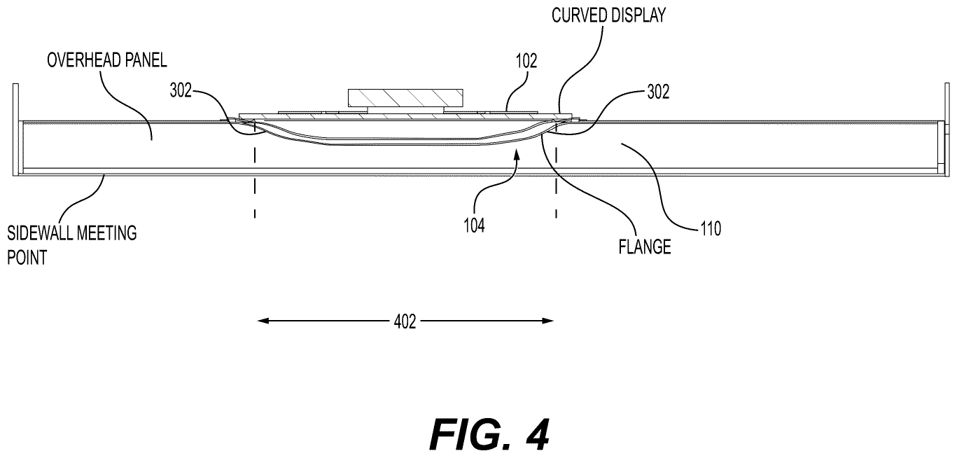

Shown in FIG. 1 is an upwards perspective view within a cabin 100 of an aircraft. Referring to the figure, the curved screen skylight 101 is shown installed within a ceiling 110 of the aircraft. The ceiling 110 includes the overhead panel which has curvature to conform to the ceiling 110 of the aircraft cabin and, as shown in FIG. 1, is curved and generally forms the overhead portion of the fuselage above the sidewalls 106. In some embodiments, an overhead panel may have curvature on one side which conforms to ceiling 110 and on the other side may be substantially flat such the overhead portion of the cabin is substantially level. The sidewalls 106 are generally the side portions of the fuselage including the windows. The ceiling 110 forms the generally overhead portion of the aircraft cabin 100 with the curved display screen 102 of the curved screen skylight 101 being positioned at the highest peak of the ceiling 110. The ceiling 110 may have a length which spans the length of the cabin 100 (FIG. 4) and a radius-of-curvature greater than the curved screen skylight 101 as further described below in connection with FIG. 3. On the ceiling 110, the curved screen skylight 101 comprises a display frame 104 which creates an edge establishing a perimeter around the curved display screen 102 and conforms to the curvature of the ceiling 110 and overhead panel.

Additionally, the display frame 104 shown in FIG. 1 could also vary in size, direction, and orientation, any of which should not be considered limiting within the scope of this application. The display frame 104 is shown in FIG. 1 to enclose the region where the curved display screen 102 of skylight 101 is capable of displaying imagery. The display frame 104 may be fabricated from a material different than curved display screen 102 and may or may not be capable of displaying visual imagery. The display frame 104 may be equipped with lighting elements (e.g. LEDs) to illuminate a portion or all of the display frame 104. In embodiments, the display frame 104 shown in FIG. 1 has a fixed geometry comprising of at least 4 connected sides. The length and angles created from the connected sides of the display frame 104 can be arranged in a variety of different ways to alter the enclosed region where the display screen 102 of skylight 101 can display imagery. In one possible orientation, shown in FIG. 1, the display frame 104 is orientated such that an approximate hexagon shape is created around the curved display screen 102 where the image display may be shown. The display frame 104 may optionally protrude outwards from the ceiling 110 (or overhead panel) at a greater distance than the skylight 101 or may be flush with the skylight 101 and/or curved display screen 102. Shown in FIG. 1, the curved display screen 102 of skylight 101 displays imagery in segments with each skylight 101 being enclosed by a separate display frame 104. The count, size, and shape of each skylight 101 can vary depending on the designed implementation. For example, the curved screen skylight 101 could display imagery on the curved display screen 102 in one continuous display frame 104 (not shown) or in many different frames 104 as shown in FIG. 1. For instance, in the embodiment depicted in FIG. 1, four skylights 101 are shown. In other embodiments (not shown), there may be one, two, three, five or more skylights 101. The number and size of the skylights may be varied depending on the size of the aircraft fuselage and other design considerations such as the width of the ceiling 110.

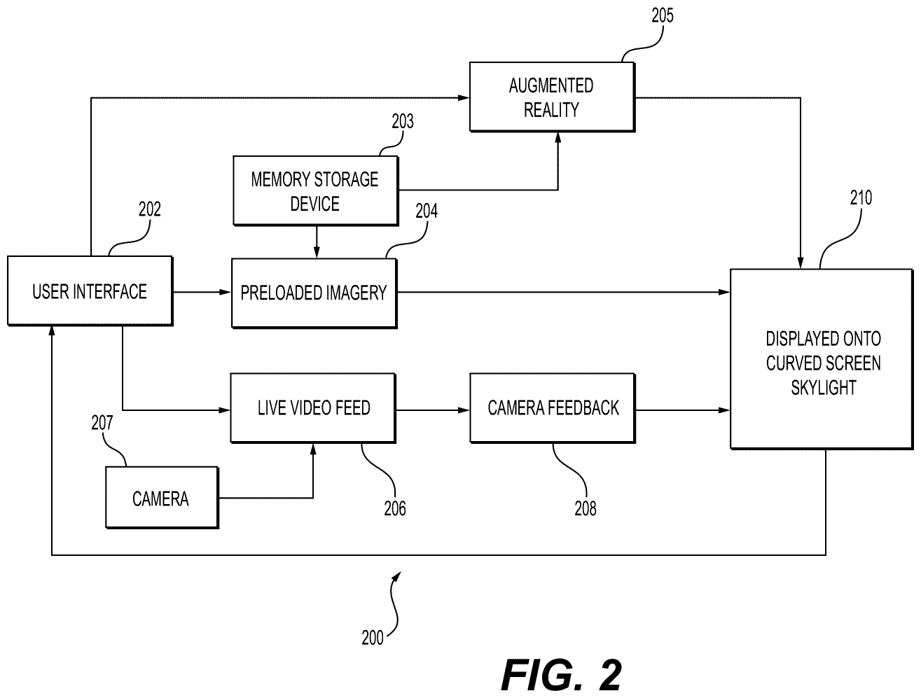

The disclosed embodiments include a method to allow a user to display virtual imagery onto the virtual skylight. Shown in FIG. 2 is a method 200 for a user to control different imagery to be displayed onto the curved display screen 102 of curved screen skylight 101. A user interface 202 is used to provide a selectable menu for a user to make a selection determining the imagery to be displayed virtually onto the display screen 102 of curved screen skylight 101.

To begin, a selection is made using a user interface 202 for the curved display screen 102 to either display 1) a live video feed 206 from the camera 207, 2) preloaded imagery 204 stored on the memory storage device 203, or 3) augmented reality imagery stored on the memory storage device. to be disposed onto the display screen 102 of curved screen skylight 101. In some embodiments, additional selectable options such as powering off/on the curved display screen 102 may be included. The user interface 202 may be interactive for an aircraft occupant using a wide variety of applications and should not be considered limiting within the scope of this application. In some embodiments, user interface 202 may be a human machine interface having a display screen and selectable menu with options for a user to select and interact with. In embodiments, from the user interface 202, imagery can be selected which has been preloaded 204 or live imagery 206.

In embodiments, live imagery 206 is captured by a camera 207 positioned on the aircraft externally or internally. The camera 207 may be used to record imagery to be used as preloaded imagery 204. The preloaded imagery 204 can be possibly stored on a memory stick 203 or any known device having non-transitory memory that could be used to store a recorded image or video. For example, the camera 207 can be enabled and then disabled to record any length of time and the corresponding video can be stored onto the device. Augmented reality 205 may include a fully or partially simulated environment and have interactive capabilities. Augmented reality 205 may be stored on the memory stick 203.

If a selection is made on the user interface 202 selecting preloaded imagery, preloaded imagery 204 stored on memory storage device 203 may be displayed onto the display screen 102 of curved screen skylight 101 at block 210. For example, preloaded imagery 204 may be selected by a user midflight or pre-flight using user interface 202 and displayed onto the display screen 102 of curved screen skylight 101 disposed on the ceiling 110 of the cabin 100.

If a selection is made on user interface 202 for live imagery 206 to be displayed on the curved display screen 102, camera 207 captures images or video and the camera feedback (in real-time or near real-time) 208 is displayed onto the display screen 102 of curved screen skylight 101 at block 210. For example, a user could select for live imagery 206 to be displayed onto the display screen 102 on the ceiling 110 of the cabin 100. In this case, the camera 207 would be activated and the camera feedback 208 will be displayed onto the curved display screen 102.

If a selection is made on user interface 202 for augmented reality 205 to be displayed on the curved display screen 102, augmented display feeds stored in memory storage device 203 are displayed on curved display screen 102 at block 210. For example, a user could select for augmented reality 205 to be displayed onto the display screen 102 on the ceiling 110 of the cabin 100. The method 200 can then proceed back to the user interface 202 for continuous feedback or adjustment.

FIG. 3 shows a cross sectional view of the ceiling 110 of the aircraft with the curved screen skylight 101 installed. The curvature shown in embodiments should not be considered limiting within the scope of this application and is simply a term describing the arc of the cabin ceiling created by the aircraft fuselage. The curvature is shown to provide a possible implementation and shape of the curved screen skylight 101 and curved display screen 102 to substantially conform to the shape of the aircraft fuselage. As such, the length, shape, and amount of the curvature may vary depending on the shape and size of the aircraft fuselage so that the fuselage profile is substantially maintained by the skylight 101. The radius-of-curvature of the ceiling 110 may be greater than that of the curved screen skylight 101 and/or display screen 102. For example, the radius-of-curvature of the curved screen skylight 101 may be about 36-inches to about 38-inches, while the radius-of-curvature of the ceiling 110 may be about 46-inches to about 50 inches. In the embodiment depicted in FIG. 3, the radius-of-curvature of the skylight 101 is approximately 37-inches while the radius-of-curvature of the ceiling 110 is approximately 48-inches. However, the radial dimensions of the curved screen skylight 101 and ceiling 110 may vary and should not be considered limiting within the scope of this application.

A ceiling width 308 indicates a span of the ceiling portion of the fuselage. Due to the curvature of the fuselage, a seamless transition between the sidewalls 106 and the ceiling 110 of the fuselage may mean that the location where the sidewalls 106 end and the ceiling 110 begins is arbitrarily determined, or may be determined based upon where the ceiling 110 attaches to the sidewalls 106. However, in embodiments the sidewalls 106 generally form the sides of the fuselage and include the windows, whereas the ceiling 110 generally forms the overhead portion and includes the overhead panel of the fuselage above the windows. In embodiments, the ceiling width 308 is about 60-inches to about 65-inches. In certain embodiments, the ceiling width 308 is about 62-inches.

As shown in FIG. 3, two flanges 302 extend/are attached from the aircraft ceiling 110 and overlap opposite sides of the display screen 102 of curved screen skylight 101. The flanges 302, in embodiments, are part of display frame 104 and are shaped to follow the curvature of the ceiling and overlap the display screen 102 with a close fit. The overlap of the flanges 302 allows the curved screen skylight 101 to be embedded and substantially secured in the ceiling 110 with a viewable width 306 between the flanges 302. The viewable width 306 is the width viewable from the aircraft cabin in which the curved screen skylight 101 can display imagery. In embodiments, the viewable width 306 is about 15-inches to about 25-inches wide. In some embodiments, the viewable width 306 is about 18-inches to about 20-inches wide. In certain embodiments, the viewable width 306 is approximately 19-inches wide. The overlap and taper of each flange 302 reduces the visible area of the curved screen skylight 101 from the interior of the cabin and creates an appearance of a skylight being behind the interior surface of ceiling 110. In embodiments, curved screen skylight 101 may be approximately thirty to fifty inches long by approximately fifteen to thirty inches wide. More specifically, curved screen skylight may be approximately forty-one inches by 19 inches in a vestibule, approximately forty-four inches by 27 inches in a forward club, and approximately thirty-four inches by nineteen inches in an aft club/lavatory.

FIG. 4 is a cross sectional view perpendicular to the cross section shown in FIG. 3. The flanges 302 extend from the aircraft ceiling 110 and overlap a distance of the display screen 102 on opposing ends. The display frame 104 and flanges 302 are shown to extend to opposing edges of the curved display screen 102 and with curvature conforming to the cabin ceiling. Both the curved display screen 102 and display frame 104 are mounted to the ceiling 110. The viewable length 402 is the length between the flanges 302 and is the length of the display screen 102 viewable to the aircraft cabin to display imagery. In embodiments, the viewable length 402 of the curved display screen 102 is about 35-inches to about 55-inches long. In some embodiments, the viewable length 402 is about 40-inches to about 50-inches long. In certain embodiments the viewable length 402 is approximately 45-inches long.

Many different arrangements of the various components depicted, as well as components not shown, are possible without departing from the spirit and scope of what is claimed herein. Embodiments have been described with the intent to be illustrative rather than restrictive. Alternative embodiments will become apparent to those skilled in the art that do not depart from what is disclosed. A skilled artisan may develop alternative means of implementing the aforementioned improvements without departing from what is claimed.

It will be understood that certain features and subcombinations are of utility and may be employed without reference to other features and subcombinations and are contemplated within the scope of the claims. Not all steps listed in the various figures need be carried out in the specific order described.

The invention claimed is:

1. A curved screen skylight for an aircraft comprising:
a curved display screen substantially conformed to a ceiling of an aircraft cabin;
a camera configured to provide a real-time external view from the aircraft and a memory storage device, wherein the camera and the memory storage device are communicatively coupled with the curved display screen;
a user interface operatively coupled with the camera and the memory storage device;
wherein the curved display screen is configured to display 1) a live video feed from the camera or 2) preloaded imagery stored on the memory storage device, and
wherein the user interface enables a selection of the live video feed or the preloaded imagery to be displayed on the curved display screen.

2. The curved screen skylight of claim 1 comprising an overhead panel having curvature to conform to the ceiling.

3. The curved screen skylight of claim 2 comprising a display frame disposed around a perimeter of the curved display screen and configured to conform to the curvature of the overhead panel such that the display frame frames the curved display screen.

4. The curved screen skylight of claim 3 wherein the display frame includes lighting elements which illuminate the display frame.

5. The curved screen skylight of claim 3 comprising flanges which extend around a perimeter of the display frame and overlap an outer edge of the curved display screen.

6. The curved screen skylight of claim 5 wherein the flanges are configured to embed the curved display screen within the overhead panel.

7. The curved screen skylight of claim 5 wherein a viewable width is created in between the flanges such that the curved display screen displays either the preloaded imagery or the live video feed within the viewable width, and
the viewable width is in a range of 15 inches to 25 inches wide.

8. The curved screen skylight of claim 5 wherein a viewable length is created in between the flanges such that the curved display screen displays either the preloaded imagery or the live video feed within the viewable length, and
the viewable length is in a range of 35 inches to 55 inches long.

9. The curved screen skylight of claim 1 wherein the user interface enables a selection for augmented reality to be displayed on the curved display screen, and the augmented reality is stored on the memory storage device.

10. A method for having a curved screen skylight for an aircraft, the method comprising:
conforming a curved display screen to attach to a curved ceiling of an aircraft cabin;
configuring a camera onto the aircraft and communicatively connecting the camera to a memory storage device and the curved display screen; and
displaying at least one of, a live video feed from the camera, or preloaded imagery stored on the memory storage device onto the curved display screen.

11. The curved screen skylight of claim 10 comprising providing a user interface operatively coupled to the curved display screen, wherein the user interface is configured to display a selectable menu on a human machine interface.

12. The curved screen skylight of claim 11 wherein the selectable menu is configured to enable selection of either a) a live video feed from the camera, or b) preloaded imagery stored on the memory storage device, for displaying on the curved display screen.

13. The curved screen skylight of claim 12 comprising disposing a display frame around the curved display screen and conforming the display frame to an overhead panel, such that the display frame encloses an outer portion of the curved display screen.

14. The curved screen skylight of claim 13 comprising embedding the curved display screen into the overhead panel and securing the curved display screen using flanges extending from the overhead panel.

15. The curved screen skylight of claim 13 comprising conforming the curved display screen to the overhead panel such that a standup height is substantially maintained inside the aircraft cabin.

16. A curved screen skylight for an aircraft comprising:
a curved display screen configured to be at least partially embedded into an aircraft ceiling;
a camera communicatively connected to a memory storage device and the curved display screen;
wherein the curved display screen is configured to display at least one of: a live video feed from the camera, or preloaded imagery stored on the memory storage device.

17. The curved screen skylight of claim 16 comprising a user interface configured to enable a selection for displaying either the live video feed from the camera or the preloaded imagery stored on the memory storage device.

18. The curved screen skylight of claim 16 comprising a display frame configured to create an edge around the curved display screen and attach to the aircraft ceiling.

19. The curved screen skylight of claim 16 wherein a radius of curvature of the curved display screen is less than a radius of curvature of the aircraft ceiling.

20. The curved screen skylight of claim 16 comprising flanges configured to extend from the aircraft ceiling and secure the curved display screen to the aircraft ceiling such that the curved display screen appears substantially embedded within the aircraft ceiling.
